(19) United States
(12) Patent Application Publication
(10) Pub. No.: US 2006/0214394 A1
(43) Pub. Date: Sep. 28, 2006

(54) Multi-directional skates

(76) Inventor: Michael H. Seid, Roselle, NJ (US)

Correspondence Address: LITMAN LAW OFFICES, LTD, PO BOX 15035, CRYSTAL CITY STATION, ARLINGTON, VA, 22215, US

(21) Appl. No.: 11/312,567

(22) Filed: Dec. 21, 2005

Related U.S. Application Data
(60) Provisional application No. 60/665,928, filed on Mar. 28, 2005.

(51) Int. Cl. B62B 7/00

(52) U.S. Cl. 280/642

(57) ABSTRACT

The multi-directional skates are a pair of roller skates, with each skate being an assembly having a skate boot, at least four roller assemblies, and a skid plate. The skate boot is a traditional in-line/aggressive skate-type boot including an upper shoe portion and a sole portion. The roller assemblies each include a substantially spherical roller or ball that act as rolling surfaces for skate, allowing it to create movement in any direction, not just forward and backward, but also sideways and complete 360 degree movement. The number and alignment of the roller assemblies may be modified according to the desires of the individual skater, but they are intended to be aligned such that each skate is capable of balancing itself it an upright position.

### CROSS-REFERENCE TO RELATED APPLICATION

This application claims the benefit of U.S. Provisional Patent Application Ser. No. 60/665,928, filed Mar. 28, 2005.

### BACKGROUND OF THE INVENTION

1. Field of the Invention

The present invention relates to roller skates, and more specifically to multi-directional roller skates.

2. Description of the Related Art

In-line roller skates, often referred to as roller blades, are extremely popular skates that offers the skater both speed and maneuverability. A typical roller blade has either four or five polyurethane wheels linearly aligned and mounted within a wheel frame. The wheel frame can be attached to a variety of different boot types, depending upon the needs of the skater. Attached to the boot and/or skate frame is a toe stop, heal stop, or both. Uses of roller blades range from simple recreational skating to professional extreme skating and roller hockey.

As roller blade use has increased, so have the demands placed on the skate assembly. For example, free-style and extreme skaters perform difficult skating maneuvers and tricks on both flat and sloping surfaces, using both in-line skates and skateboards. In order to perform increasingly difficult maneuvers and tricks, these skaters not only need the ability to create linear motion, i.e., movement in forward and backward directions, but also the ability for lateral motion, i.e., side-to-side movement.

What is needed is a roller skate that allows the skater to create controlled movement in every direction, thus increasing the number and difficulty of the maneuvers and tricks that can be performed, not only by roller blade users, but tricks performed by skateboarders as well. It is also desirable that the skates allow a user to balance himself in an upright and stationary position when on a flat surface, as opposed to traditional in-line skates.

Thus, a multi-directional skate solving the aforementioned problems is desired.

### SUMMARY OF THE INVENTION

The multi-directional skates are a pair of roller skates, with each skate being an assembly having a skate boot, at least four roller assemblies, and a skid plate. The skate boot is a traditional in-line/aggressive skate-type boot including an upper shoe portion and a sole portion. The roller assemblies are coupled to the sole portion of the skate boot and depend such that they make contact with the skating surface.

The roller assemblies each include a substantially spherical roller or ball that acts as a rolling surfaces for the skate, allowing it to create movement in any direction, not just forward and backward. The number and alignment of the roller assemblies may be modified according to the desires of the individual skater, but they are intended to be aligned such that each skate is capable of balancing itself in an upright position.

The skid plate is placed over the roller assemblies and affixed to the sole portion of each skate. Apertures are provided in the skid plate for receiving the roller assemblies and the skid plate acts to hide any hardware that may have been used to couple the roller assemblies and the skate boot. The function of the skid plate is also to allow the sole of the skate to be protected and slide easier when tricks that include grinding are being done. For added safety, each skate may be equipped with either a standard front impact brake, as is found on many traditional roller skates, or a standard rear impact brake, as is found on many traditional in-line skates.

These and other features of the present invention will become readily apparent upon further review of the following specification and drawings.

### BRIEF DESCRIPTION OF THE DRAWINGS

FIG. 1 is a perspective view of a multi-directional skate assembly according to the present invention.

FIG. 2 is a bottom plan view of a multi-directional skate assembly according to the present invention with the skid plate removed.

FIG. 2A is a perspective view of a flange-mounted ball transfer unit to be used as a roller assembly on a multi-directional skate assembly according to the present invention.

FIG. 3 is an exploded, perspective view of a multi-directional skate assembly according to the present invention.

FIG. 4 is a side plan view of a first alternate embodiment of a multi-directional skate assembly according to the present invention.

FIG. 5 is a side plan view of a second alternate embodiment of a multi-directional skate assembly according to the present invention.

Similar reference characters denote corresponding features consistently throughout the attached drawings.

### DETAILED DESCRIPTION OF THE PREFERRED EMBODIMENTS

The present invention is a multi-directional skate assembly, shown generally as 10 in the drawings.

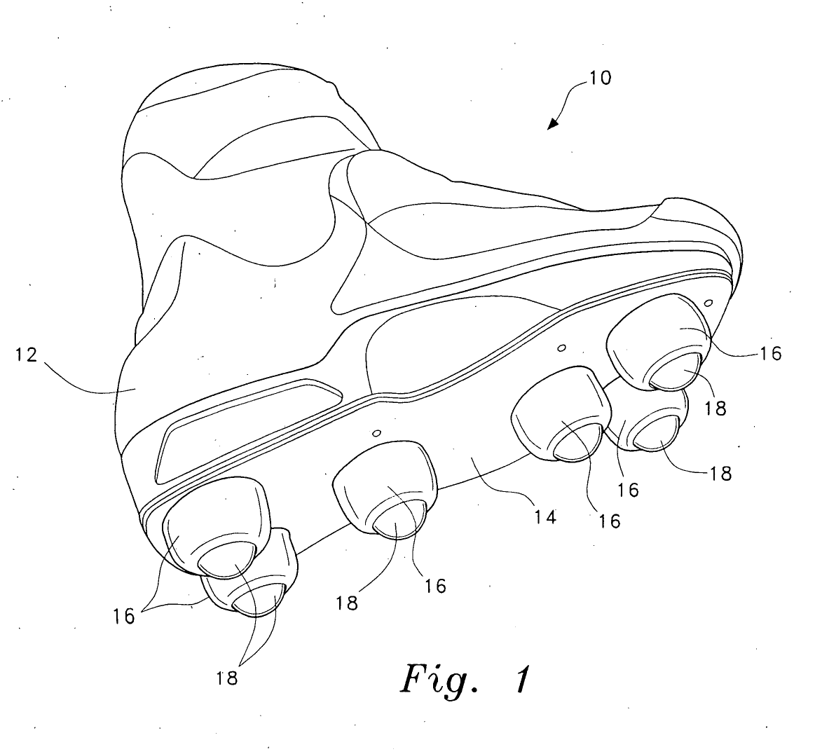

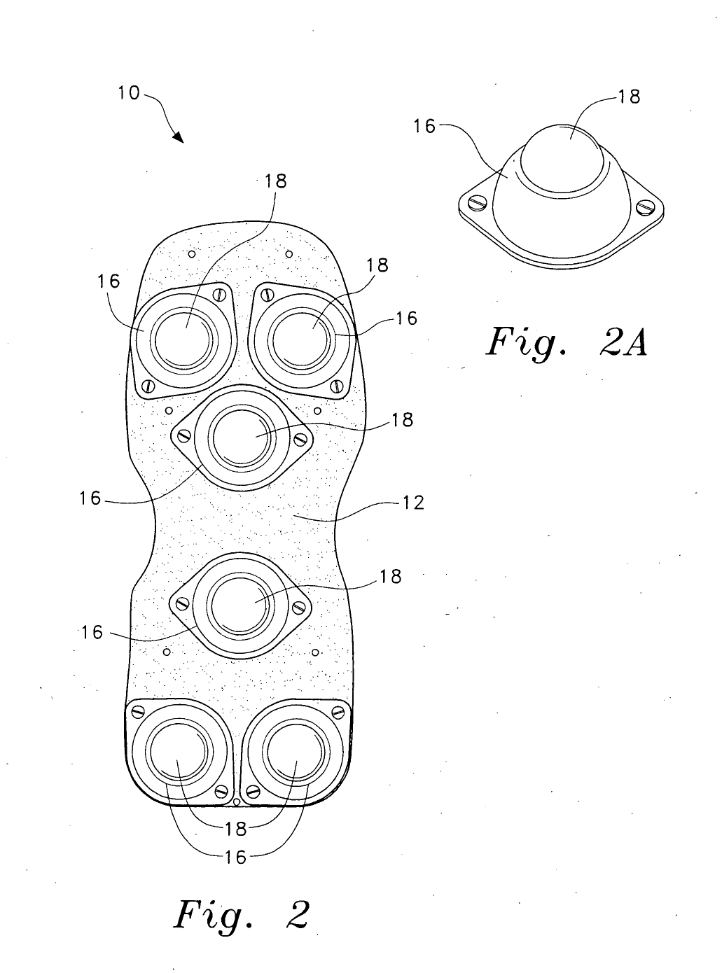

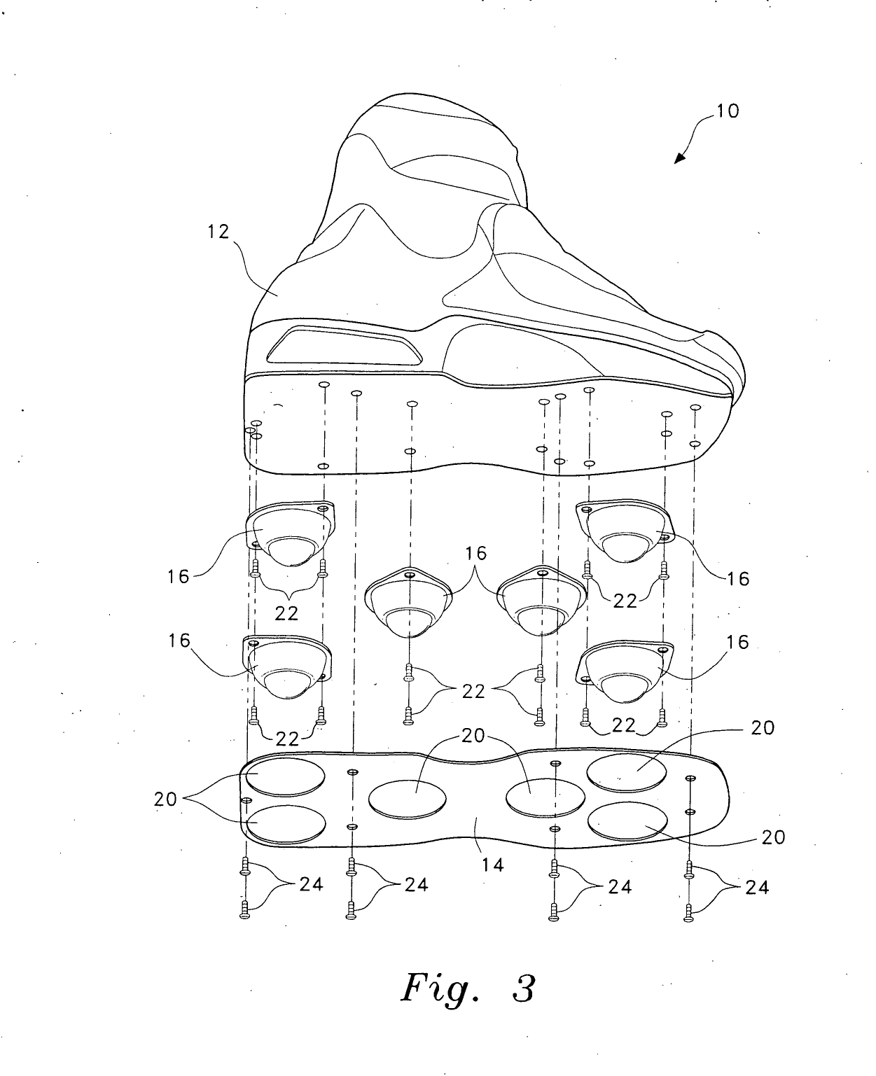

Referring to FIGS. 1, 2, 2A, and 3, multi-directional skate 10 is shown having skate boot 12, roller assemblies 16, and skid plate 14. Skate boot 12 is a traditional in-line/aggressive skate-type boot including an upper shoe portion and a sole portion. Skate boot 12 is fabricated according to standard practices and can be made of any of a variety of materials. For example, the various components of a skate boot (e.g., ankle support, tongue, sole, toe, etc.) are typically made of a polymer, although cloth or nylon fabric, elastomeric material (e.g., natural or synthetic rubber), leather, and lightweight metal may also be used, either singly or in combination. The primary considerations in designing skate boot 12 are the intended user (e.g., professional extreme skater versus casual or recreational roller skater) and the desired price. The present invention is intended for use with skate boot 12 regardless of its design, although the manner in which multi-directional skate 10 is constructed may vary depending upon both the boot's design and the intended user.

Each roller assembly 16 is coupled to skate boot 12 and depends from the sole of skate boot 12. Each roller assembly includes a substantially spherical roller ball 18. Spherical rollers balls 18 are the only portion of multi-directional skate 10 that contact the skating surface while on flat ground and have a complete 360-degree range of motion, allowing multi-directional skate 10 to create movement in any direction. In a preferred embodiment, roller assemblies 16 are provided in a sufficient enough quantity and are aligned in such a manner that multi-directional skate 16 is capable of supporting itself in an upright position. Although multi-directional skate 16 is shown with six roller assemblies, both fewer and greater numbers can be used. The decision as to the number of roller assemblies 16 to be used is primarily driven by the intended user's performance needs.

In a preferred embodiment, roller assemblies 16 are standard flange-mounted ball transfer units with carbon or stainless steel housings and carbon or stainless steel roller balls 18. In such an embodiment, roller assemblies 16 are permanently secured to the sole portion of skate boot 12 with the use of fasteners 22. Again, the structure and material of roller assemblies 16 can be varied depending on the intended use of the skate and the individual user's performance needs.

Skid plate 14 is affixed to the sole portion of skate boot 12 over the top of roller assemblies 16 and has apertures 20 that are designed to fit closely over roller assemblies 16. Skid plate 14 acts as both a cosmetic and functional feature of multi-directional skate 10. Cosmetically, skid plate 14 acts to hide the attachment features, such as the flanges and fasteners 22, of roller assemblies 16, leaving exposed only the roller balls 18 and the other necessary portions of roller assemblies 16. Functionally, skid plate 14 acts to protect the skate from wear and tear that may occur during extreme skating, including “grinding” or “rail grinding”. Skid plate 14 may also be made from a material that allows multi-directional skate 10 to perform better during such extreme skating. In a preferred embodiment, skid plate 14 is made from a fiberglass-reinforced nylon.

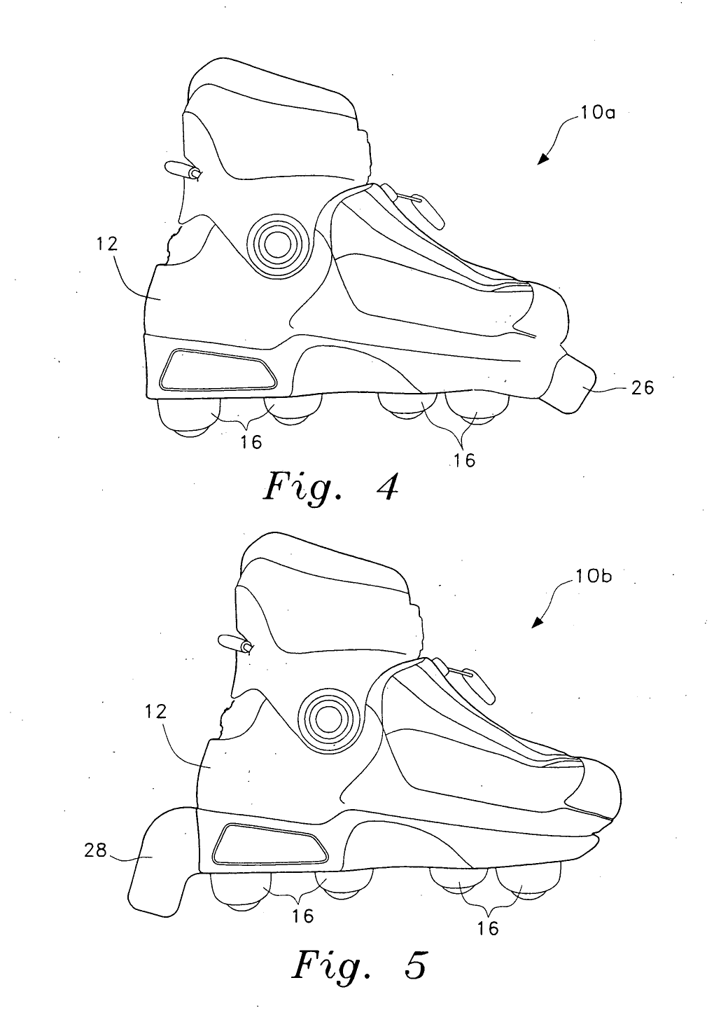

FIGS. 4 and 5 show alternate embodiments of multi-directional skate 10a and 10b. Multi-directional skate 10a is constructed in the manner described above but includes a front impact brake 26. Front impact brake 26 is a traditional front impact brake similar to those that can be found on standard roller skates and acts to brake motion of multi-directional skate 10a as a user tilts it in a forward motion.

Multi-directional skate 10b is also constructed in the manner described above but includes a rear impact brake 28. Rear impact brake 28 is a traditional rear impact brake similar to those that can be found on standard in-line skates or roller blades and acts to brake motion of multi-directional skate 10b as a user tilts it in a backward motion.

It is to be understood that the present invention is not limited to the embodiments described above, but encompasses any and all embodiments within the scope of the following claims.

I claim:

1. A multi-directional skate assembly, comprising:
a skate boot having an upper shoe portion and a lower sole portion;
at least four roller assemblies coupled to and depending from the sole portion of the skate boot; and
a skid plate affixed to the sole portion of the skate boot, the skid plate having at least four apertures, each aperture for receiving a roller assembly.

2. The multi-directional skate assembly according to claim 1, wherein six roller assemblies are coupled to and depending from the sole portion of the skate boot, the six roller assemblies being arranged such that the multi-directional skate will balance in an upright position.

3. The multi-directional skate assembly according to claim 2, further comprising a front impact brake.

4. The multi-directional skate assembly according to claim 2, further comprising a rear impact brake.

5. A multi-directional skate assembly, comprising:
a skate boot having an upper shoe portion and a lower sole portion;
at least four roller assemblies coupled to and depending from the sole portion of the skate boot, wherein the at least four roller assemblies are flange-mounted ball transfer units; and
a skid plate affixed to the sole portion of the skate boot, the skid plate having at least four apertures, each aperture for receiving a roller assembly.

6. The multi-directional skate assembly according to claim 5, further comprising a front impact brake.

7. The multi-directional skate assembly according to claim 5, further comprising a rear impact brake.

8. The multi-directional skate assembly according to claim 5, wherein six roller assemblies are coupled to and depending from the sole portion of the skate boot, the six roller assemblies being arranged such that the multi-directional skate will balance in an upright position.

9. A multi-directional skate assembly, comprising:
a skate boot having an upper shoe portion and a lower sole portion;
at least four roller assemblies coupled to and depending from the sole portion of the skate boot, wherein the at least four roller assemblies are flange-mounted ball transfer units, the at least four roller assemblies being arranged such that the multi-directional skate will balance in an upright position; and
a skid plate affixed to the sole portion of the skate boot, the skid plate having at least four apertures, each aperture for receiving a roller assembly.

10. The multi-directional skate assembly according to claim 9, further comprising a front impact brake.

11. The multi-directional skate assembly according to claim 9, further comprising a rear impact brake.

12. The multi-directional skate assembly according to claim 9, wherein six roller assemblies are coupled to and depending from the sole portion of the skate boot, three roller assemblies being arranged triangularly near a toe section of the sole portion of the skate boot, three roller assemblies being arranged triangularly near a heel section of the sole portion of the skate boot.
